(19) United States
(12) Patent Application Publication
(10) Pub. No.: US 2011/0236291 A1
(43) Pub. Date: Sep. 29, 2011

(54) SYSTEM FOR PRODUCING SILICON WITH IMPROVED RESOURCE UTILIZATION

(76) Inventors: Juergen Erwin Lang, Karlsruhe (DE); Hartwig Rauleder, Rheinfelden (DE); Bodo Frings, Schloss Holte (DE)

(21) Appl. No.: 13/132,166

(22) PCT Filed: Nov. 19, 2009
(86) PCT No.: PCT/EP2009/065466

§ 371 Date: Jun. 1, 2011

Related U.S. Application Data
(60) Provisional application No. 61/118,821, filed on Dec. 1, 2008.

(30) Foreign Application Priority Data
Dec. 1, 2008 (DE) 10 2008 059 769.4

(51) Int. Cl. C01B 33/02; C09C 1/48; B01J 19/00

(52) U.S. Cl. 423/349; 422/156; 422/600

(57) ABSTRACT

The present invention relates to a system for producing silicon, preferably high-purity silicon, particularly solar silicon, and to a method for producing silicon, preferably high-purity silicon, in particular solar silicon, in each case with particularly effective resource utilization and reduced emission of pollutants.

The present invention provides a plant for producing silicon, preferably high purity silicon, in particular solar silicon, and a method for producing silicon, preferably high purity silicon, in particular solar silicon, in each case with particularly efficient resource utilization and reduced emission of pollutants.

Thanks to the plant according to the invention, it is possible to achieve considerable process intensification in the production of silicon, in particular solar silicon, which results in a distinct reduction in climate-damaging carbon dioxide and/or carbon monoxide and in significantly reduced electrical energy requirements. Furthermore, due to recirculation of silicon oxide, which is formed on reduction of silicon dioxide to silicon in an arc furnace, into the carbon black reactor and recirculation of the silicon dioxide arising during carbon black production into the reduction reactor, a silicon oxide cycle is formed by which silicon oxide wastes are largely or ideally even completely avoided. Furthermore, the new plant also distinctly increases the material balance of the silicon used in the overall process, whereby overall less silicon oxide need be introduced into the process as starting material.

Hitherto, the waste heat, i.e. the thermal energy, arising during the production of carbon black has not been made technically and economically usable for other processes. At present, the waste heat from carbon black methods is conventionally used for prewarming or preheating the educts, such as natural gas and oil, for the same method. Correspondingly, the waste heat from silicon production, in particular in the form of hot process gases, has hitherto also merely been quenched with air and passed through hot gas filters to separate out silicon dioxide. It has not hitherto been possible to make the considerable quantities of thermal energy from carbon black or silicon production usable in order to save energy in other processes. In particular when producing high purity carbon blacks or silicon which is suitable for producing solar silicon or also for producing semiconductor silicon, transfer of the excess thermal energy was inconceivable due to the necessary spatial separation of certain processes for the production of high purity products. The extremely elevated requirements regarding the respective purity of the products and the possibility of mutual contamination absolutely ruled out this possibility.

A method for producing carbon blacks which may be mentioned by way of example and is representative of the production methods familiar to experts is the gas black method (German Imperial Patent 292 61, German patents DE 2931907, DE 671739, Carbon Black, Prof. Donnet, 1993 by MARCEL DEKKER, INC, New York, pages 57ff), in which a hydrogen-containing carrier gas charged with oil vapor is combusted at numerous outlet ports in an excess of air. The flames impinge against water-cooled rollers, which terminates the combustion reaction. A proportion of the carbon black formed in the interior of the flame is deposited on the rollers and is scraped off the latter. The carbon black remaining in the waste gas stream is separated in filters. The channel black method (Carbon Black, Prof. Donnet, 1993 by MARCEL DEKKER, INC, New York, pages 57ff) is furthermore known, in which a plurality of small natural gas-fueled flames burn against water-cooled iron channels. The carbon black deposited on the iron channels is scraped off and collected in a hopper.

The stated processes, which are mentioned as representative of all carbon black production methods, give rise to a large quantity of waste heat, in particular in the form of hot residual gases (tail gas) and hot steam. Waste heat has hitherto been partially removed from the gases, for example by means of condensers, after which the gases are purified and exhausted to the environment. No meaningful use has hitherto been made of the removed waste heat.

Due to the fine particulate structure of carbon blacks, contamination of other parts of the plant with carbon black cannot be ruled out. For this reason, such plants have not been combined on one production site with other plants which were likewise used for producing high purity compounds.

On the other hand, when producing silicon oxide, in particular silicon dioxide, such as precipitated silica or silica which has been purified by means of ion exchangers, an input of particularly large quantities of energy is required, for example for drying the moist silicon oxides.

The object of the present invention was therefore to develop an efficient plant for producing silicon, in particular solar silicon, by reducing silicon dioxide and, in so doing, to cut raw materials usage. A further object was to develop an overall plant which can be operated with the lowest possible requirement for resources, in particular raw materials and thermal and electrical energy.

Further objects which are not explicitly stated are revealed by the overall context of the following description, drawings and claims.

The objects are achieved by the plant according to the invention, in particular as an overall or also partial plant, and the use according to the invention corresponding to the features of the independent claims; preferred embodiments are disclosed in the subclaims and in the description.

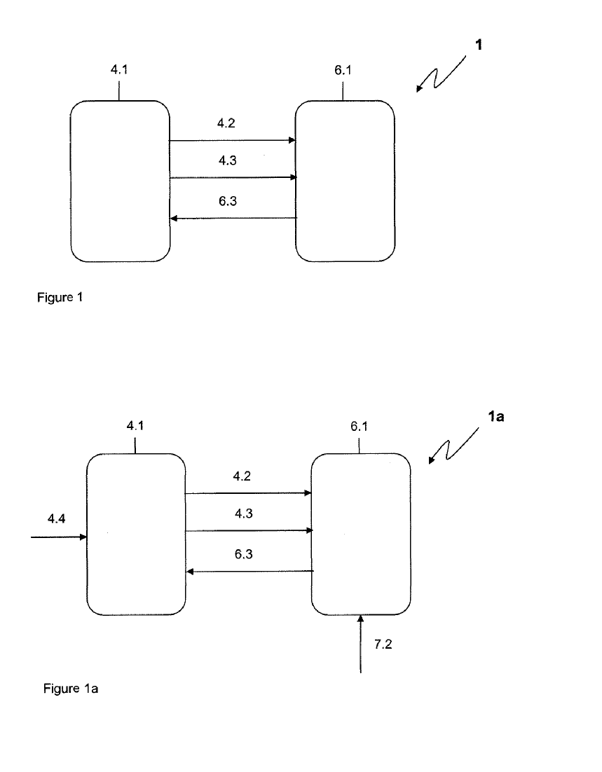

According to the invention, the present invention provides an overall plant 1 according to FIG. 1 with at least one reactor 4.1 for the thermal conversion of carbon-containing compounds and at least one reactor 6.1 for reducing metallic compounds, wherein the reactor 6.1 is supplied with the carbon produced in the reactor 4.1, preferably in the form of carbon black or charcoal or the pyrolysis product of at least one carbohydrate, via the material stream 4.2 and with the silicon dioxide arising as secondary product in the reactor 4.1 via the material stream 4.3 and additionally the mixture of carbon monoxide and silicon monoxide arising as by-product in the reactor 6.1 is returned to the reactor 4.1 via the material stream 6.3.

In a preferred embodiment of this plant (1a), the plant is supplied, preferably continuously, with silicon dioxide, preferably high purity silicon dioxide, via material stream 7.2 and with a carbon-containing compound, preferably natural gas, oil or carbohydrates such as for example sugar and other mono-, di-, tri-, oligo- or polysaccharides, via 4.4 and high purity silicon (material stream not shown in the figures) is drawn off from the reactor 6.1.

The plants according to the invention are distinguished by specific circulation of silicon, which ensures that the silicon introduced in the form of an oxide is almost quantitatively, i.e. at least 80%, preferably 90 to 100%, particularly preferably 95 to 99.5%, very particularly preferably 97 to 99%, converted into preferably high purity silicon and almost no silicon is lost as a waste product in the form of an oxide thereof.

In a first preferred variant of the method according to the invention, the present invention provides an overall plant 2 which, in addition to the components of the overall plant 1, comprises a device or machine or installation 8.1 for further processing of the silicon dioxide stream 4.3 and the carbon stream 4.2, such that the material streams 4.2 and 4.3 are fed to 8.1 and the product of this further processing is fed to the reactor 4.1 via a material stream 8.2. Circulation of SiO/SiO₂ between reactors 4.1 and 6.1 is thus retained, 8.1 merely constituting a further plant component. The overall plant 2 thus comprises at least one reactor 4.1 for the thermal conversion of carbon-containing compounds, at least one reactor 6.1 for reducing metallic compounds and at least one device or machine or installation 8.1 for further processing of the silicon dioxide stream 4.3 and of the carbon stream 4.2. In this variant, carbon, preferably in the form of carbon black or charcoal or of the pyrolysis product of at least one carbohydrate, is produced in the reactor 4.1 for the thermal conversion of carbon-containing compounds and supplied via 4.2 to the further processing apparatus 8.1. The silicon dioxide, preferably in powder form, arising as a by-product in the reactor 4.1 for the thermal conversion of carbon-containing compounds is likewise supplied via 4.3 to further processing 8.1. The further processing device/machine/installation 8.1 preferably comprises a mixing unit in which carbon and silicon dioxide are mixed as homogeneously as possible and/or a unit for producing shaped articles of carbon and silicon dioxide. The shaped articles may be produced, for example, by granulation, tableting, pelletizing, briqueting or other suitable measures well known to a person skilled in the art. The resultant products are then supplied via 8.2 to the reduction furnace 6.1. In the reduction furnace 6.1, the mixture of carbon and silicon dioxide is converted into high purity elemental silicon which is drawn off (not shown in the figures). By-products arising from this reaction include silicon monoxide, carbon monoxide and carbon dioxide. The silicon and the carbon monoxide are valuable raw materials in the process according to the invention and are therefore recirculated via 6.3 into the reactor 4.1.

The material streams 4.2 and 4.3 may take the form of separate line systems, but it is however also possible to transfer both the carbon from 4.2 and the silicon dioxide from 4.3 to the reactor 4.1 in one line for further processing 8.1.

Depending on the particle size of the carbon or of the silicon dioxide from 4.2 or 4.3 respectively, it may be advantageous also to carry out a grinding step during further processing 8.1. In this case, the plant according to the invention comprises a grinding apparatus. Grinding, mixing and production of the shaped articles may be performed in 8.1 as in each case separate steps in separate machines, but also partially or completely simultaneously in one machine.

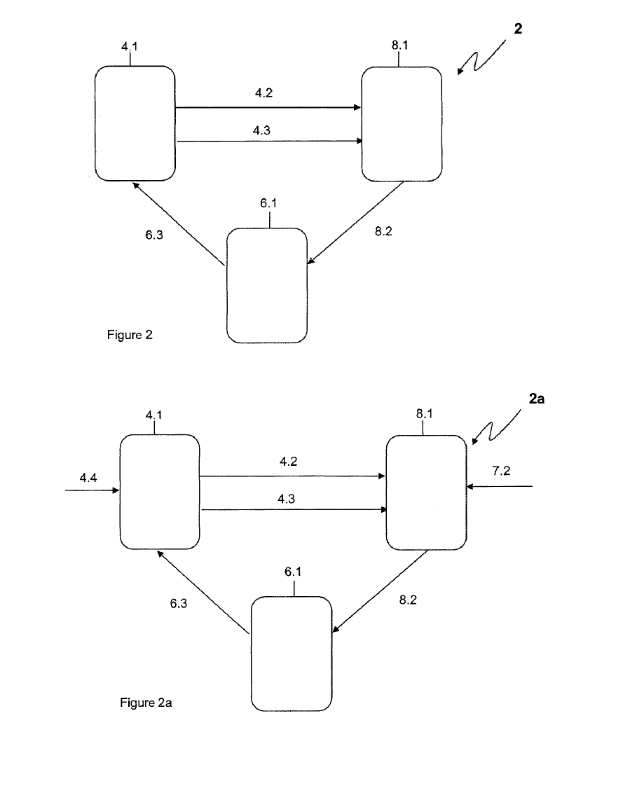

In another variant of the present invention, the raw materials are supplied, preferably continuously, to the circulation of materials via 7.2 and 4.4, wherein silicon dioxide, preferably high purity silicon dioxide, is supplied via 7.2 and a source of carbon via 4.4. High purity silicon is drawn off from the reactor 6.1 (material stream not shown in the figures). The specific circulation of silicon in the plant according to the invention ensures that the silicon introduced in the form of an oxide is obtained almost quantitatively as high purity silicon and almost no silicon is lost as a waste product in the form of one of the oxides thereof. In comparison with the embodiments according to FIGS. 1 and 1a, the embodiments according to FIGS. 2 and 2a exhibit the advantage that the raw materials silicon dioxide and carbon from streams 4.2 and 4.3 can be supplied by the further processing unit 8.1 to the reduction reactor 6.1 as a homogeneous mixture in ideal stoichiometry. As a result and also due to the shape of the shaped article, the efficiency of the reduction reactor can be distinctly improved and its energy usage distinctly reduced.

Reactors suitable for the thermal conversion of carbon-containing compounds 4.1 are any reactors for producing carbon black, graphite, charcoal or in general a compound containing a carbon matrix, for example carbons also containing silicon carbide and further such compounds familiar to a person skilled in the art. According to the invention, the reactor 4.1 for the thermal conversion of carbon-containing compounds is a reactor or furnace for producing carbon black or for the combustion and/or pyrolysis of carbohydrates, for example the pyrolysis of sugar optionally in the presence of silicon dioxide, for producing carbon-containing matrices, for example in the presence of high purity silicon oxide. Conventional reactors for producing carbon black are operated at process temperatures of 1200 to above 2200° C. in the combustion chamber. The best known methods for producing carbon black are the lamp black method, the furnace black method, the gas black method, the flame black, acetylene black or thermal black method. The reactor 4.1 is accordingly preferably designed for carrying out the stated methods. A reactor known from the prior art for producing carbon black or for the thermal conversion of carbon-containing compounds is preferably used for the plant according to the invention. Such reactors are sufficiently well known to a person skilled in the art. The furnace black reactor, the feedstock for which is clean oil fractions, i.e. which have for example been prepurified by distillation, is preferred according to the invention as the reactor 4.1. Decisively, the content of contaminants is here determined by the raw material selected.

Conventional types of reactors in general comprise any furnaces which are suitable for producing carbon black. These may in turn be equipped with different burner technologies. One example thereof is the Hüls arc furnace. The decisive factor in selecting the burner is whether it is desired to produce an elevated temperature in the flame or a rich flame. The reactors may comprise the following burner units: gas burners with integral combustion air blower, gas burners for a swirled air stream, combination gas burners with gas injection via peripheral lances, high velocity burners, Schoppe impulse burners, parallel diffusion burners, combined oil/gas burners, pusher furnace burners, oil vaporization burners, burners with air or steam atomization, flat flame burners, gas-fired jacketed jet pipes, together with any burners and reactors which are suitable for producing carbon black or for the pyrolysis of carbohydrates, for example of sugar, optionally in the presence of silicon dioxide. The reactor 4.1 is taken to be the entire reactor or also parts of the reactor, for example the reactor comprises the reaction chamber, a combustion zone, a mixing zone, reaction zone and/or quench zone. According to the invention, recuperators are used in the quench zone, such as for example a jet recuperator with a ring of steel pipes.

The reactor 6.1 for reducing metallic compounds, the reduction reactor, is particularly preferably an arc furnace, an electric melting furnace, a thermal reactor, an induction furnace, a melting reactor or a blast furnace. In one very particularly preferred embodiment, the reactor 6.1 and/or the reactor 4.1, preferably both of them, are of an airtight construction, such that penetration of oxygen is avoided.

The line 6.3 in the plant according to the invention is particularly preferably designed as a hot gas line in such a way that it as far as possible suppresses any condensation of the gaseous silicon oxide from the hot process gases which arise during production of silicon in the reduction reactor 6.1. The hot process gases conventionally comprise carbon monoxide, silicon oxide and/or carbon dioxide. Condensation of silicon oxide entails a considerable risk of abrupt decomposition. The hot gas line is accordingly preferably provided on its interior surface with “blanketing”, which reduces or preferably prevents such condensation on the interior surface of the hot gas line. Blanketing may for example be provided by generating vortex swirls or by other measures known to a person skilled in the art. As an alternative to blanketing, the hot gas line 6.3 may be equipped with heat tracing and/or comprise over its surface a producer gas feed for temperature control, in particular for increasing temperature by reaction, preferably in the wall zone. Self-evidently, the hot gas line 6.3 should be made as short as possible, i.e. the outlet of the waste gas stream 6.3 from the reduction reactor and the inlet into the reactor 4.1 for the thermal conversion of carbon compounds should be arranged as close as possible to one another. A person skilled in the art can devise such a plant design on the basis of his/her general specialist knowledge.

Further constituents of the hot process gases transferred into the reactor 4.1 include carbon monoxide and silicon oxide. In the underlying method, introducing silicon oxide into the reactor for producing carbon black or for pyrolysis of carbohydrates is not disruptive if the reaction products are used for producing silicon. Introducing carbon monoxide from the hot process gases via the hot gas line 6.3 into the reactor 4.1 also results, in addition to reducing the required quantity of natural gas or oil or sugar as a source of carbon (4.4), in a favorable shift in the equilibrium of the hot gas during combustion or thermal cleavage of the carbon black raw materials or the carbohydrate-containing compounds. The mode of operation enabled in the plant according to the invention is accompanied by a distinct reduction of carbon monoxide and/or carbon dioxide in the overall process for producing silicon.

Thanks to recirculation of the hot process gases from the reduction step in 6.1 into the reactor 4.1 and recirculation of the silicon dioxide from 4.1, which arises as a by-product of carbon recovery in 4.1, into 6.1, it is possible, on the one hand, to dispense with a separate, complex and costly dedusting installation and, on the other hand, to increase the yield of silicon by up to 20 mol % in comparison with prior art methods, because the silicon oxide formed always remains in the process and only the desired final product silicon is drawn off from the reactor 6.1. The overall process by means of the plant according to the invention using specific material streams and a specific plant design may accordingly lead to an increase in yield of silicon with regard to the introduced silicon oxide. Thanks to the introduced heat tonality of the hot gases, there is also for example a simultaneous reduction in the quantity of natural gas in carbon black production.

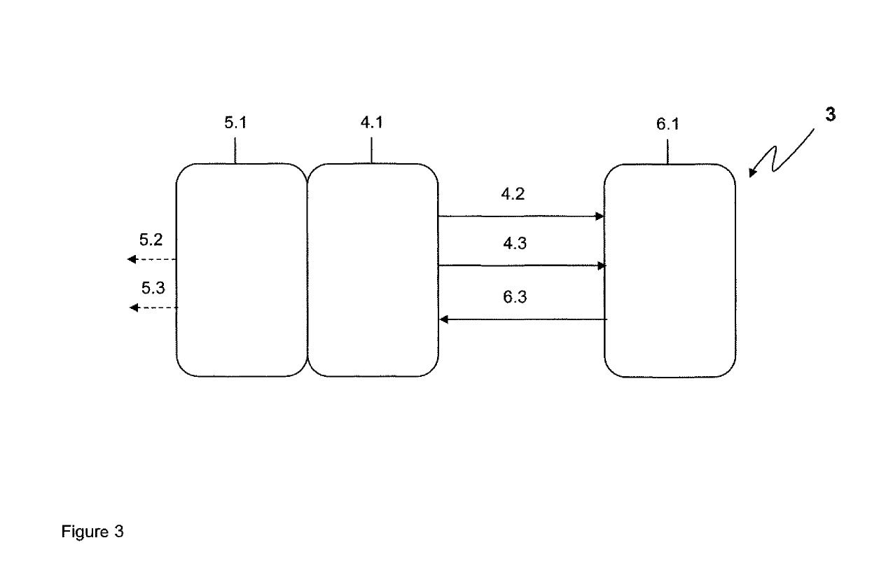

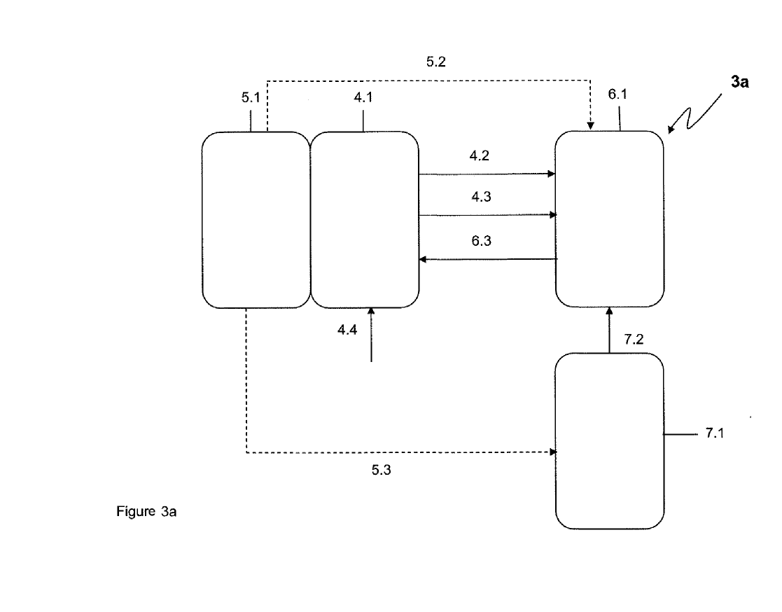

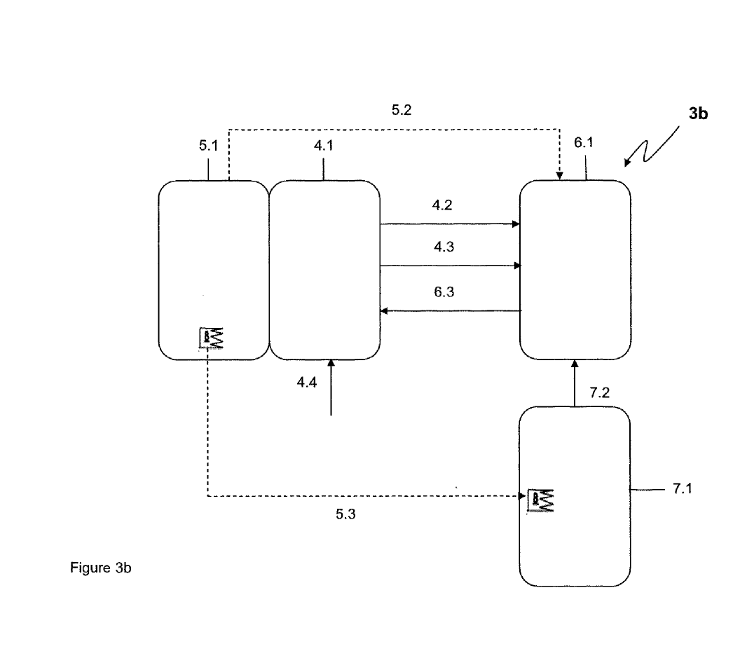

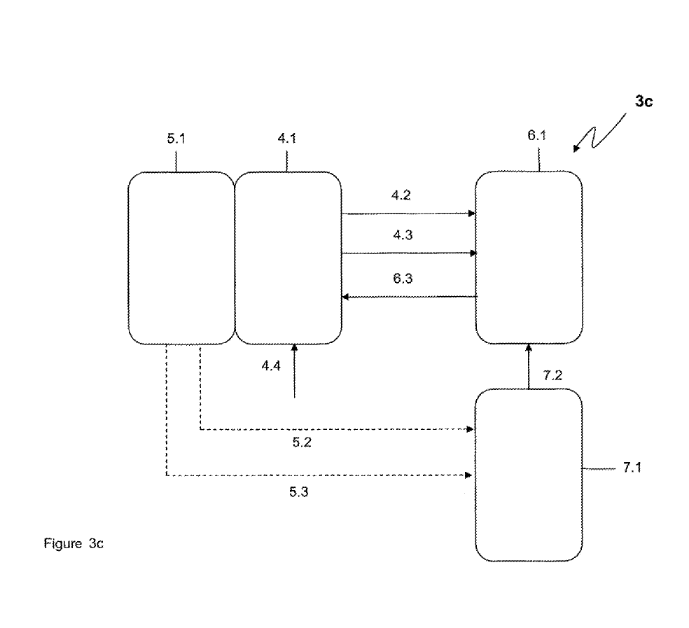

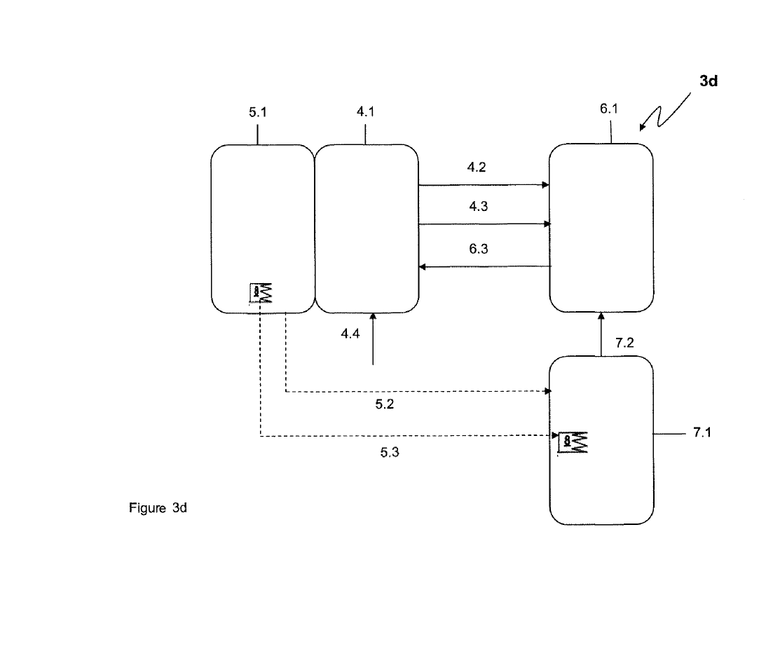

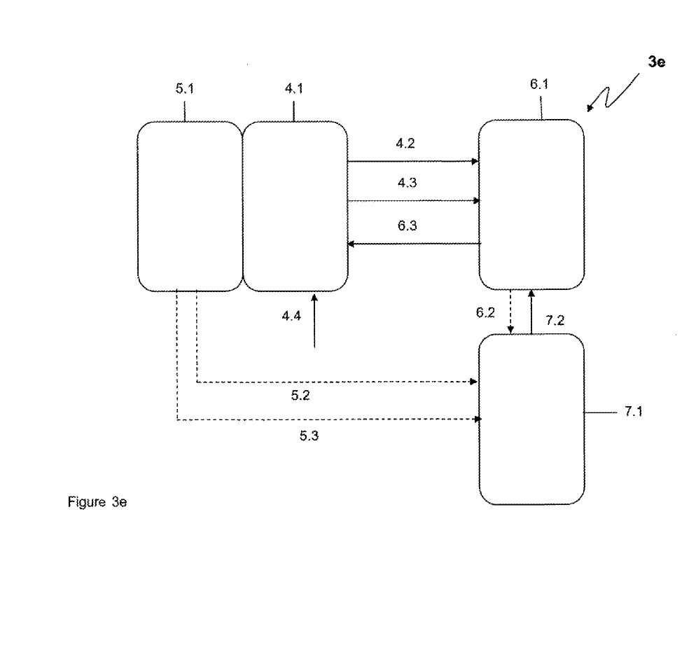

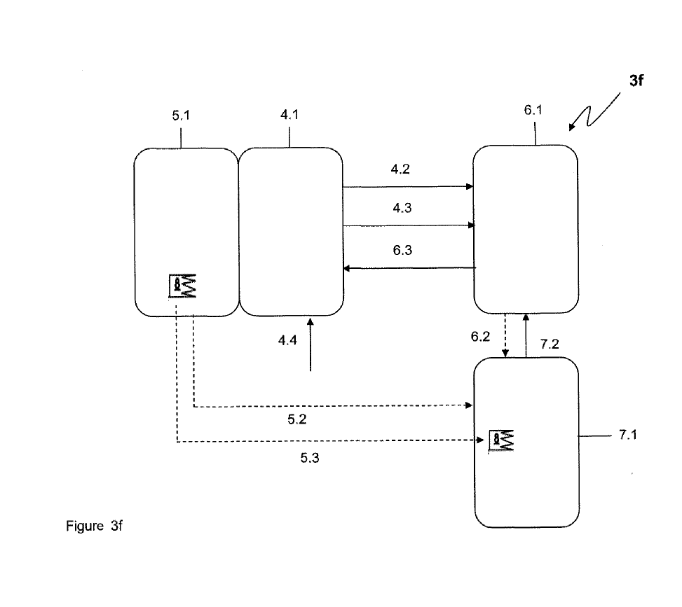

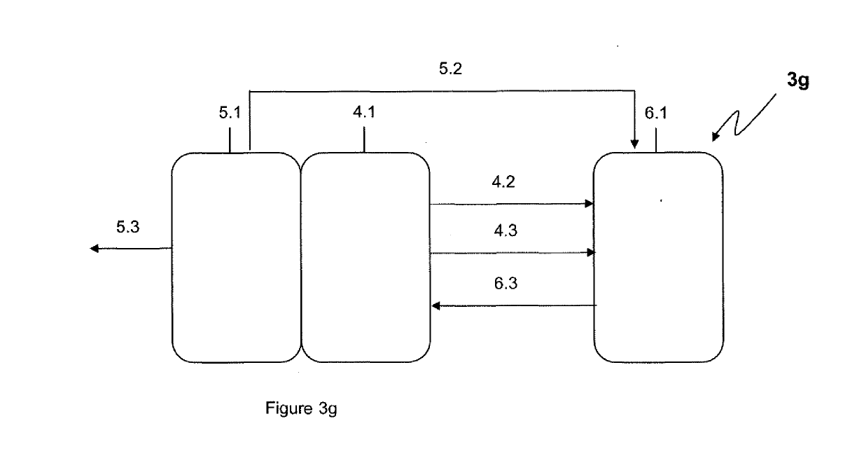

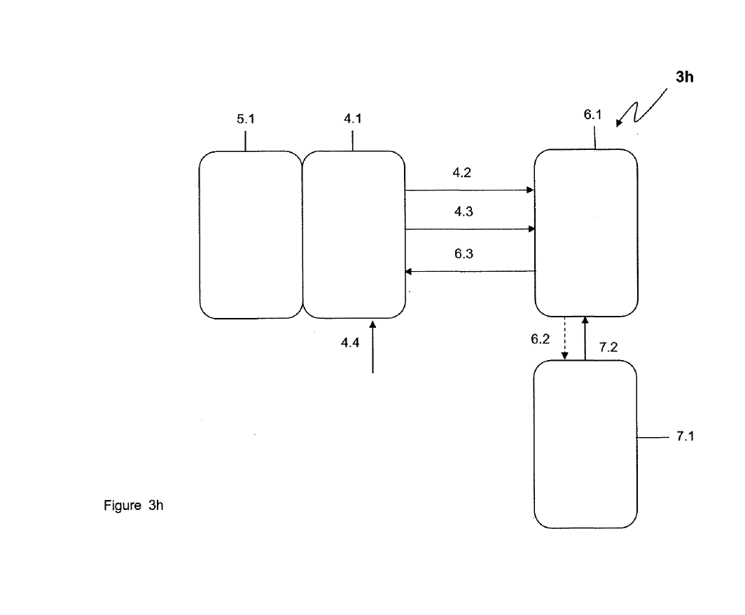

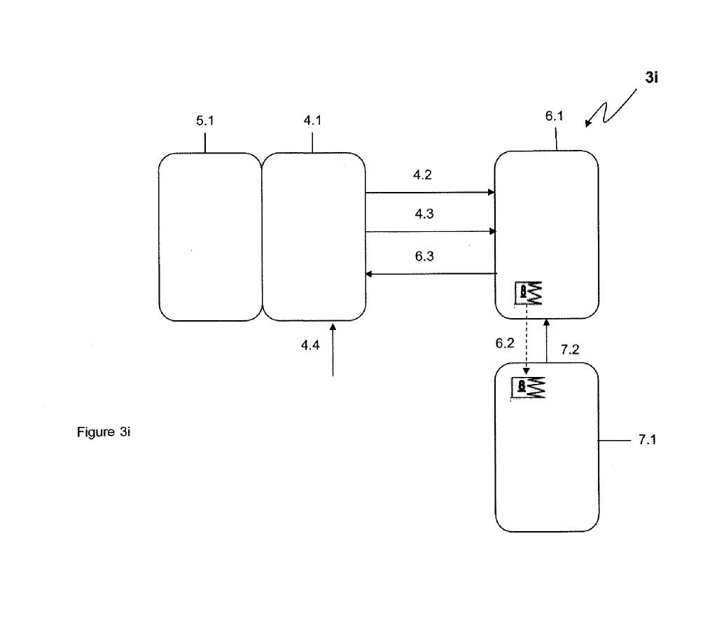

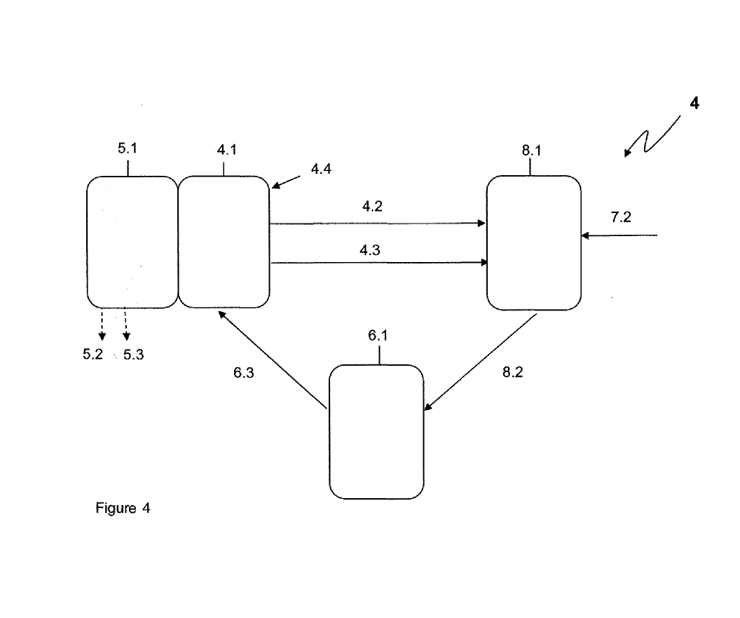

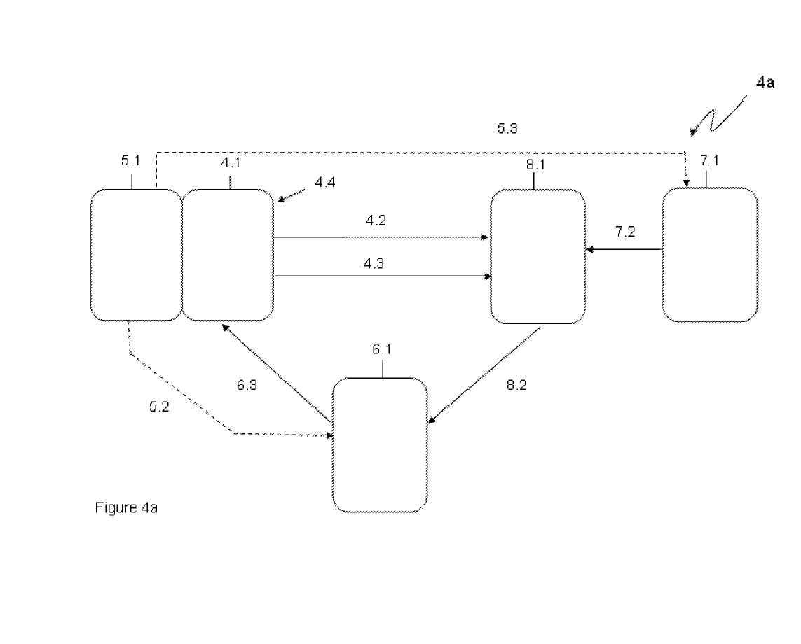

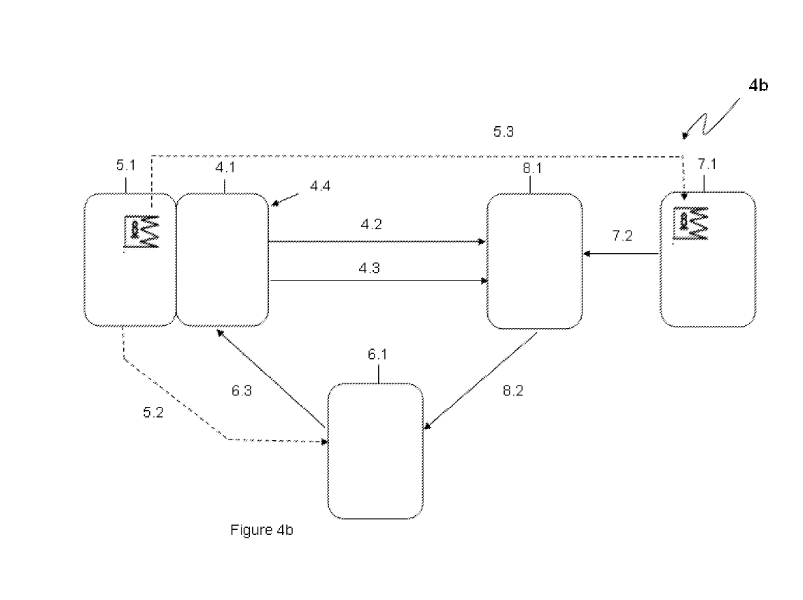

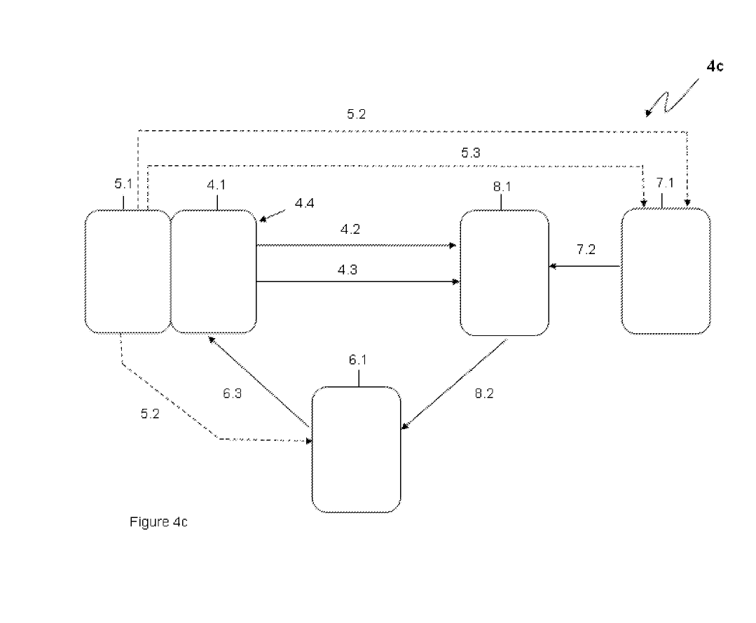

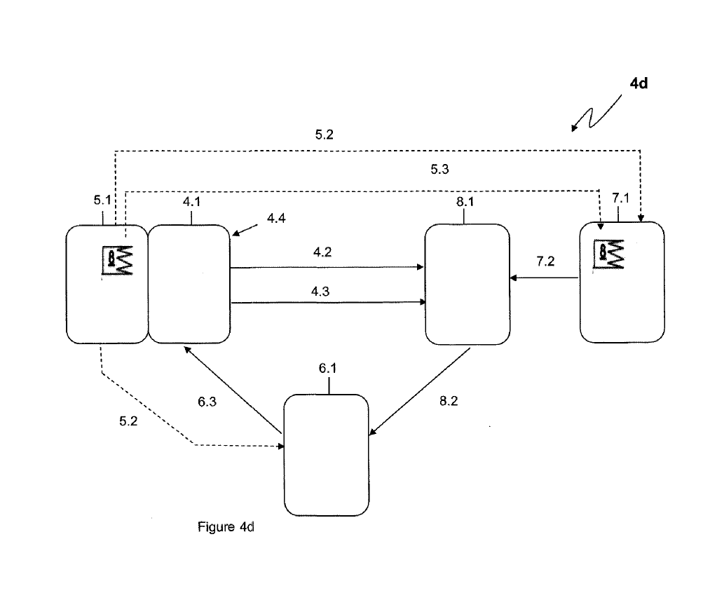

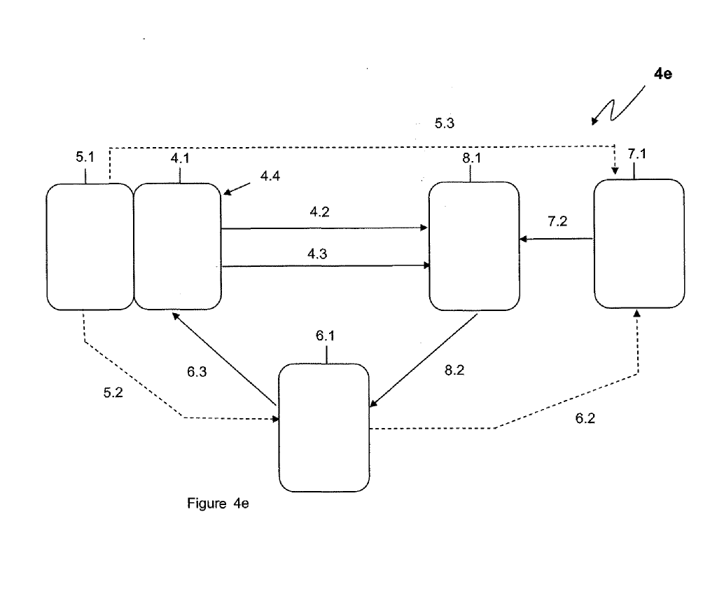

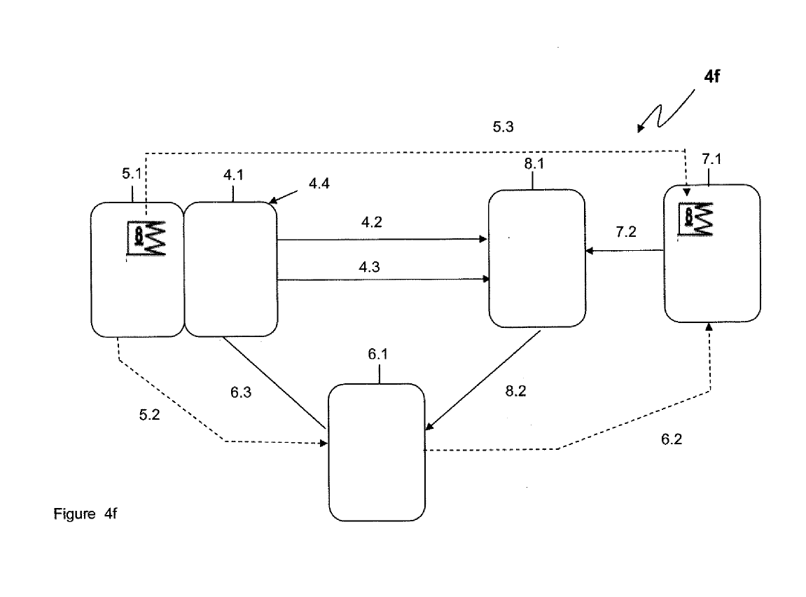

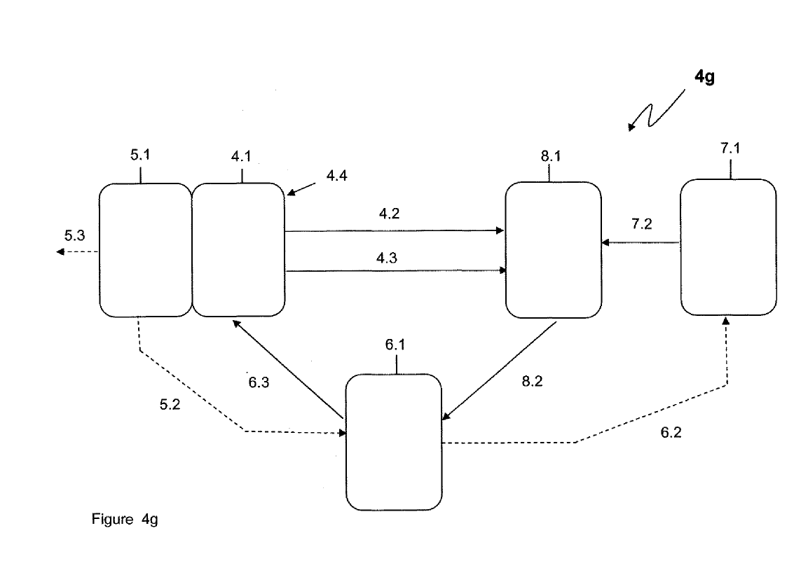

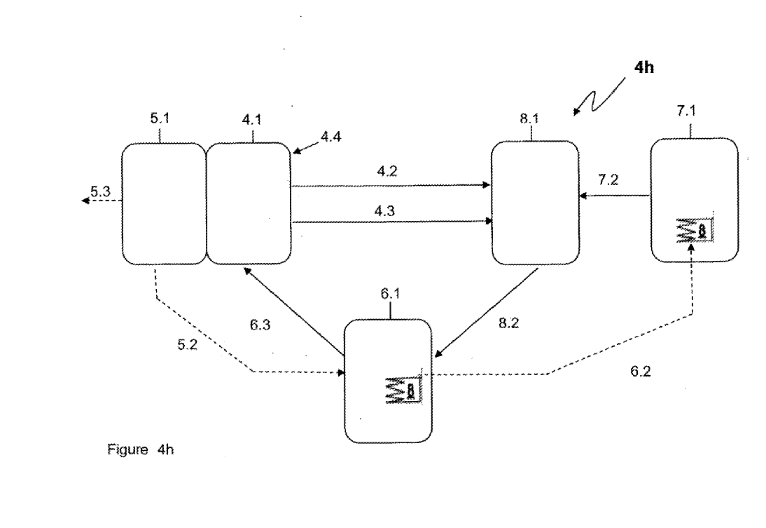

The plant according to the invention for producing high purity silicon may be operated still more efficiently if, in addition to the specific material streams, specific energy streams are also used. The following description provides a detailed explanation of these energy streams. These energy streams complement the material streams which have previously been described and, in preferred variants of the present invention, are used together with the energy streams described below. In FIGS. 3 to 3i and 4 to 4h, the material streams are represented with continuous lines and the energy streams with broken lines.

In preferred variants of the plant according to the invention, the present invention provides an overall plant 3 or 4 comprising a reactor 4.1 for the thermal conversion of carbon-containing compounds, wherein the reactor is connected to a combined heat and power cycle 5.1, via which a proportion of the waste heat 5.3 is extracted from the thermal conversion and another proportion of the waste heat is converted into electrical energy 5.2. The plants additionally comprise a reduction reactor 6.1 and, in plant 4, a device/machine/installation 8.1 for further processing of material streams 4.2 and 4.3. The plants 3 and 4 furthermore comprise material streams 4.2, 4.3, 4.4, 6.3, 7.2 and 8.2, which are configured as described above.

In a preferred variant of these plants 3a or 4a, the extracted waste heat 5.3 in the method for producing silicon dioxide, in particular in a method step during the production of silicon dioxide, is used in device 7.1. The waste heat is particularly preferably indirectly or directly used in the device 7.1 for heating or temperature control of the precipitation vessel for forming precipitated silicas or silica gels and/or for drying silicon oxide, in particular silicon dioxide, such as precipitated silica or silica gels or silica gels purified by ion exchangers. The waste heat 5.3 is particularly preferably directed into 7.1, as shown in FIGS. 3b and 4b, via heat exchangers 8, preferably in a secondary circuit. According to a preferred alternative, SiO₂ may be directly dried in 7.1 with superheated steam 5.3. Contact dryers can be operated with low-temperature steam 5.3.

The electrical energy obtained from the combined heat and power cycle 5.2 may be used for supplying energy to a reactor 6.1 for reducing metallic compounds (see plants 3a, 3b, 4a and 4b), for producing silicon dioxide (see plants 3c, 3d, 4c and 4d), particularly preferably in the production of precipitated silica, pyrogenic silica or silica gels, and/or preferably be used for drying and/or for temperature control during precipitation, in device 7.1. It is likewise possible to use the electrical energy in 7.1 for operating a kiln in the production of pyrogenic silica. The overall plant makes it possible to provide the production of silicon dioxide and of carbon black at one site and optionally to provide the reactor 6.1 for reducing metallic compounds at another location via an electric power grid. It may furthermore be advantageous to supply at least a proportion of the electrical energy obtained from the combined heat and power cycle 5.1 to further processing 8.1 via an energy stream 5.4 (not explicitly shown in the Figures).

The combined heat and power cycle may be provided by devices 5.1 or installations 5.1 which are sufficiently well known to a person skilled in the art. The combined heat and power cycle has substantially better efficiency than pure electricity generation from thermal power stations. In particularly preferred cases, the utilization rate of a combined heat and power cycle may amount to up to 90 percent. According to the invention, the combined heat and power cycle may not only be power- and heat-operated, but also exclusively power-operated or heat-operated. A combined heat and power cycle generally operates with hot steam, which drives steam turbines, by means of which electricity is then generated. Steam is extracted and introduced into a heat exchanger generally before the final turbine stage, preferably in methods for producing silicon dioxide, such as for example for temperature control or for drying of silicon oxide, in a device 7.1. In the plant according to the invention, extraction may also conveniently proceed after the final turbine stage. Conventionally, temperature control of a precipitation vessel or drying of the silicon oxide, such as precipitated silica or a silica gel, proceeds for example via heat exchangers, thus via a secondary circuit. As described above, it is likewise possible to make direct use of the waste heat for drying. The combined heat and power cycle may obtain the waste heat from carbon black production, such as preferably from the quench zone or other hot parts of the reactor, for example via heat exchangers or direct use of process vapors and/or from combustion of the tail gases, which may in turn serve to produce steam. The combined heat and power cycle is preferably operated with steam. The tail gases contain inter alia steam, hydrogen, nitrogen, Cx, carbon monoxide, argon, H₂S and carbon dioxide. The combined heat and power cycle preferably operates with back pressure, as a result of which no thermal losses occur in the steam circuit processes. Consequently, there is generally no requirement for fresh cooling water.

According to the invention, the steam from the quench zone and/or the waste heat from the combustion of the tail gases in 5.1 may be used as waste heat 5.3. Superheated steam 5.3 from 4.1 or via 5.1 may particularly preferably be used directly in a method for producing silicon dioxide, in particular for direct drying of silicon dioxide, such as silica gel or precipitated silica. Additionally or alternatively, a contact dryer (device 7.1), for example a plate dryer or preferably a tubular rotary dryer, may be operated with low-temperature steam. Using power obtained from 5.1, it is preferably also possible to operate primary dryers, in particular tower spray dryers or spin flash dryers, for drying silicon dioxide.

The waste heat from individual plant parts or also from the combustion of tail gas from carbon black production is preferably likewise used by means of heat exchangers 8 via a secondary circuit, in order to suppress any contamination of the high purity carbon blacks, carbon-containing compounds or of the high purity silicon oxide, in particular silicon dioxide, with other contaminants, such as other metals.

It is possible according to the invention to provide carbon black production and the production of silicon oxide, in particular of precipitated silica or of silica gel, on one production site or even in a common plant, because any possible mutual contamination of carbon black and silicon oxide for producing silicon, in particular solar silicon, in the reactor 6.1 is insignificant for this overall process. This combination was hitherto inconceivable, since any contamination of carbon black with silicon dioxide or of silicon dioxide with carbon black had to be avoided. In the present underlying method for producing silicon from silicon oxide, in particular silicon dioxide, and carbon black and/or pyrolyzed carbohydrates, the silicon oxide is reduced in the reactor 6.1 to yield silicon, such that for this specific application, mutual contamination of high purity carbon black, high purity pyrolyzed carbohydrates or high purity silicon dioxide is not disruptive.

If the plant according to the invention is to be used for producing solar silicon, the educts supplied by the material streams 4.4 and 7.2 have to be present in highly pure form and must not exceed the following limit values for contaminants:
aluminum at most 10 ppm, preferably between 0.001 ppm and 1 ppm, particularly preferably 0.01 ppm to 0.8 ppm, very particularly preferably 0.02 to 0.6, especially preferably 0.05 to 0.5 and very especially preferably 0.1 to 0.5 ppm,
boron at most 10 ppm, preferably at most 1 ppm, particularly preferably at most 0.1 ppm, very particularly preferably 0.001 ppm to 0.099 ppm, especially preferably 0.001 ppm to 0.09 ppm and very especially preferably 0.01 ppm to 0.08 ppm
calcium at most 10 ppm, preferably at most 1 ppm, particularly preferably less than or equal to 0.3 ppm, especially preferably 0.001 ppm to 0.3 ppm, very especially preferably 0.01 ppm to 0.3 ppm and particularly preferably 0.05 to 0.2 ppm
iron at most 10 ppm, preferably at most 1 ppm, particularly preferably less than or equal to 0.6 ppm, especially preferably 0.001 ppm to 0.6 ppm, very especially preferably 0.05 ppm to 0.5 ppm and particularly preferably 0.01 to 0.4 ppm
nickel at most 10 ppm, preferably at most 1 ppm, particularly preferably less than or equal to 0.5 ppm, especially preferably 0.001 ppm to 0.5 ppm, very especially preferably 0.01 ppm to 0.5 ppm and particularly preferably 0.05 to 0.4 ppm
phosphorus at most 10 ppm, preferably at most 1 ppm, particularly preferably less than 0.1 ppm, very particularly preferably 0.001 ppm to 0.099 ppm, especially preferably 0.001 ppm to 0.09 ppm and very especially preferably 0.01 ppm to 0.08 ppm
titanium at most 10 ppm, preferably at most 1 ppm, particularly preferably less than or equal to 1 ppm, very particularly preferably 0.001 ppm to 0.8 ppm, especially preferably 0.01 ppm to 0.6 ppm and very especially preferably 0.1 ppm to 0.5 ppm
zinc at most 10 ppm, preferably at most 1 ppm, particularly preferably less than or equal to 0.3 ppm, very particularly preferably 0.001 ppm to 0.3 ppm, especially preferably 0.01 ppm to 0.2 ppm and very especially preferably 0.05 ppm to 0.2 ppm

The SiO₂ supplied by the material stream 7.2 may be an amorphous or crystalline SiO₂, an amorphous SiO₂ being preferred and precipitated silicas, silica gels, for example aerogels or xerogels, pyrogenic silicas, mixed forms or mixtures of precipitated silicas, silica gels, and pyrogenic silicas being particularly preferred. The silicon dioxide may particularly preferably be produced according to a method comprising the following steps
a. providing an initial charge of an acidulant with a pH value of less than 2, preferably less than 1.5, particularly preferably less than 1, very particularly preferably less than 0.5
b. providing a silicate solution with a viscosity of 1 to 10000 poise
c. adding the silicate solution from step b. to the initial amount from step a. in such a way that the pH value of the precipitation suspension remains at all times at a value of less than 2, preferably less than 1.5, particularly preferably less than 1 and very particularly preferably less than 0.5
d. separating and washing the resultant silicon dioxide, the washing medium having a pH value of less than 2, preferably less than 1.5, particularly preferably less than 1 and very particularly preferably less than 0.5
e. drying the resultant silicon dioxide.

In this case, an initial charge of an acidulant or an acidulant and water is preferably metered in step a) in the precipitation vessel. The water is preferably distilled or deionized water. The acidulant may be the acidulant which is also used in step d) for washing the filter cake. The acidulant may be hydrochloric acid, phosphoric acid, nitric acid, sulfuric acid, chlorosulfonic acid, sulfuryl chloride or perchloric acid in concentrated or dilute form or mixtures of the above-stated acids. In particular, hydrochloric acid may be used, preferably 2 to 14 N, particularly preferably 2 to 12 N, very particularly preferably 2 to 10 N, especially preferably 2 to 7 N and very especially preferably 3 to 6 N, phosphoric acid, preferably 2 to 59 N, particularly preferably 2 to 50 N, very particularly preferably 3 to 40 N, especially preferably 3 to 30 N and very especially preferably 4 to 20 N, nitric acid, preferably 1 to 24 N, particularly preferably 1 to 20 N, very particularly preferably 1 to 15 N, especially preferably 2 to 10 N, sulfuric acid, preferably 1 to 37 N, particularly preferably 1 to 30 N, very particularly preferably 2 to 20 N, especially preferably 2 to 10 N. Concentrated sulfuric acid is very particularly preferably used.

In a preferred variant of this method, a peroxide is added to the initial amount in step a) in addition to the acidulant, which peroxide brings about a yellow/brown coloration with titanium(IV) ions under acidic conditions. In this case, the peroxide is particularly preferably hydrogen peroxide or potassium peroxydisulfate. As a result of the yellow/brown coloration of the reaction solution, the degree of purification during washing step d) may be very closely monitored. It has in fact emerged that titanium in particular constitutes a very tenacious contaminant, which becomes readily attached to the silicon dioxide at pH values of over 2. Disappearance of the yellow coloration in step d) usually means that the desired purity of the silicon dioxide has been reached and the silicon dioxide may be washed from this point with distilled or deionized water until a preferably neutral pH value is achieved for the silicon dioxide. In order to achieve this indicator function of the peroxide, it is also possible to add the peroxide not in step a) but rather to the water glass in step b) or as a third material stream in step c). In principle it is also possible to add the peroxide only after step c) and before step d) or during step d). The present inventions provide all the above-stated variants and mixed forms thereof. However, preferred variants are those in which the peroxide is added in step a. or b., since in this case it can exercise a further function in addition to the indicator function.

In a first preferred variant of this method, a silicate solution with a viscosity of 0.1 to 2 poise, preferably of 0.2 to 1.9 poise, particularly of 0.3 to 1.8 poise and especially preferably of 0.4 to 1.6 poise and very especially preferably of 0.5 to 1.5 poise is provided in step b). An alkali metal and/or alkaline earth metal silicate solution may be used as the silicate solution, an alkali metal silicate solution preferably being used, particularly preferably sodium silicate (water glass) and/or potassium silicate solution. Mixtures of a plurality of silicate solutions may also be used. Alkali metal silicate solutions have the advantage that the alkali metal ions can readily be separated by washing. The silicate solution used in step b. preferably exhibits a modulus, i.e. weight ratio of metal oxide to silicon dioxide, of 1.5 to 4.5, preferably of 1.7 to 4.2, particularly preferably of 2 to 4.0. The viscosity may be established, for example, by evaporating conventional commercial silicate solutions or by dissolving the silicates in water.

In a second preferred variant of this method, a silicate solution with a viscosity of 2 to 10000 poise, preferably of 3 to 5000 poise, particularly of 4 to 1000 poise, especially preferably of 4 to 800 poise, very especially preferably of 4 to 100 poise and particularly preferably of 5 to 50 poise is provided in step b). One example of a highly concentrated water glass with elevated viscosity is water glass 58/60 with a density of 1.690-1.710, an SiO₂ content of 36-37 wt. %, an Na₂O content of 17.8-18.4 wt. % and a viscosity at 20° C. of approx. 600 poise, as described in Ullmann's Encyclopedia of Industrial Chemistry, 4th revised and expanded edition, volume 21, Verlag Chemie GmbH, D-6940 Weinheim, 1982, page 411. General instructions for producing high-viscosity water glasses may also be found therein. A further example is a water glass from VAN BAERLE CHEMICAL FABRIK, Gernsheim, Germany, with a viscosity of 500 poise, relative density of 58-60, density of 1.67-1.71, Na₂O content of 18%, SiO₂ content of 37.0%, water content of approx. 45.0%, weight ratio of SiO₂:NaO approx. 2.05, molar ratio of SiO₂:NaO approx. 2.1. PQ Corporation offers water glasses for sale with viscosities of for example 15 and 21 poise. A person skilled in the art is aware that he/she can produce highly concentrated silicate solutions by concentrating lower viscosity silicate solutions or by dissolving solid silicates in water. An alkali metal and/or alkaline earth metal silicate solution may be used as the silicate solution, an alkali metal silicate solution preferably being used, particularly preferably sodium silicate (water glass) and/or potassium silicate solution. Mixtures of a plurality of silicate solutions may also be used. Alkali metal silicate solutions have the advantage that the alkali metal ions can readily be separated by washing. The silicate solution used in step b) preferably exhibits a modulus, i.e. weight ratio of metal oxide to silicon dioxide, of 1.5 to 4.5, preferably of 1.7 to 4.2, particularly preferably of 2 to 4.0. The viscosity may be established, for example, by evaporating conventional commercial silicate solutions or by dissolving the silicates in water.

In step c) of this method, the silicate solution is added to the initial amount and the silicon dioxide is thus precipitated out. Care must here be taken to ensure that the acidulant is always present in excess. The silicate solution is therefore added such that the pH value of the reaction solution is always less than 2, preferably less than 1.5, particularly preferably less than 1, very particularly preferably less than 0.5 and especially preferably 0.01 to 0.5. If necessary, further acidulant may be added. The temperature of the reaction solution is maintained during the addition of the silicate solution by heating or cooling the precipitation vessel to 20 to 95° C., preferably 30 to 90° C., particularly preferably 40 to 80° C.

Particularly effectively filterable precipitates are obtained if the silicate solution enters the initial amount and/or precipitation suspension as drops. In a preferred embodiment of the present invention, care is therefore taken to ensure that the silicate solution enters the initial amount and/or precipitation suspension as drops. This may be achieved, for example, by dropwise addition of the silicate solution to the initial amount. The dispensing unit used may be arranged outside the initial amount/precipitation suspension and/or be immersed in the initial amount/precipitation suspension.

In a further particularly preferred embodiment, the initial amount/precipitation suspension is stirred such that the flow velocity, measured in a zone extending from the surface of the reaction solution to 10 cm below the reaction surface, is from 0.001 to 10 m/s, preferably 0.005 to 8 m/s, particularly preferably 0.01 to 5 m/s, very particularly 0.01 to 4 m/s, especially preferably 0.01 to 2 m/s and very especially preferably 0.01 to 1 m/s.

In one embodiment of the above-described manufacturing method for SiO₂, the silicate solution is introduced as drops into an initial amount/precipitation suspension with a flow velocity, measured in a zone extending from the surface of the reaction solution to 10 cm below the reaction surface, of 0.001 to 10 m/s, preferably of 0.005 to 8 m/s, particularly preferably of 0.01 to 5 m/s, very particularly of 0.01 to 4 m/s, especially preferably of 0.01 to 2 m/s and very especially preferably of 0.01 to 1 m/s. It is furthermore possible in this manner to produce silicon dioxide particles which can very effectively be filtered. In contrast, in those methods in which an elevated flow velocity prevails in the initial amount/precipitation suspension, very fine particles are formed which are very difficult to filter.

In the present method, the silicon dioxide obtained according to step c) is separated in step d) from the remaining constituents of the precipitation suspension. Depending on the filterability of the precipitate, this may proceed by conventional filtration methods, for example filter presses or rotary filters, known to a person skilled in the art. In the case of precipitates which are difficult to filter, separation may also proceed by centrifugation and/or by decanting off the liquid constituents of the precipitation suspension.

Once the supernatant has been separated off, the precipitate is washed in this method, it being necessary to ensure by a suitable washing medium that the pH value of the washing medium during washing and thus also that of the silicon dioxide is less than 2, preferably less than 1.5, particularly preferably less than 1, very particularly preferably 0.5 and especially preferably 0.001 to 0.5. The washing medium used is preferably the acidulant used in steps a) and c) or mixtures thereof in dilute or undiluted form.

It is optionally possible, albeit not necessary, to add a chelating reagent to the washing medium or to stir the precipitated silicon dioxide in a washing medium containing a chelating reagent with a corresponding pH value of less than 2, preferably of less than 1.5, particularly preferably of less than 1, very particularly preferably of 0.5 and especially preferably of 0.001 to 0.5. Preferably, however, washing with the acidic washing medium proceeds immediately after separation of the silicon dioxide precipitate without further steps being performed.

Washing is continued until the washing suspension consisting of silicon dioxide according to step c) and the washing medium no longer has a visible yellow coloration. If the method according to the invention is performed in steps a) to d) without addition of a peroxide which forms a yellow/orange colored compound with Ti(IV) ions, a small sample of the washing suspension must be taken during each washing step and combined with an appropriate peroxide. This procedure is continued until the sample taken no longer has a visible yellow/orange coloration after addition of the peroxide. It must here be ensured that the pH value of the washing medium and thus also that of the silicon dioxide up to this point in time is less than 2, preferably less than 1.5, particularly preferably less than 1, very particularly preferably 0.5 and especially preferably 0.001 to 0.5.

The silicon dioxide washed in this manner is preferably further washed with distilled water or deionized water in an intermediate step d1), i.e. between step d) and e), until the pH value of the silicon dioxide obtained is 4 to 7.5 and/or the conductivity of the washing suspension is less than or equal to 9 μS/cm, preferably less than or equal to 5 μS/cm. This ensures that any acid residues adhering to the silicon dioxide have been sufficiently removed.

In the case of precipitates which are difficult to filter or wash, it may be advantageous to perform washing by passing the washing medium through the precipitate from below in a close-meshed perforated basket.

All of the washing steps may preferably be performed at temperatures of 15 to 100° C.

In order to guarantee the indicator effect of the peroxide (yellow/orange coloration), it may be advisable to add further peroxide together with the washing medium until no yellow/orange coloration is any longer discernible and only then to continue washing with washing medium without peroxide.

The resultant high purity silicon dioxide can be dried and further processed. Drying may proceed by means of any method known to a person skilled in the art, for example belt dryers, tray dryers, drum dryers etc.

It is advisable to grind the dried silicon dioxide in order to obtain an optimum particle size range for further processing to solar silicon. The methods for optional grinding of the silicon dioxide according to the invention are known to a person skilled in the art and may be looked up, for example, in Ullmann, 5th edition, B2, 5-20. Grinding preferably proceeds in fluidized bed opposed-jet mills in order to minimize or avoid contamination of the high purity silicon dioxide with metal abraded from the walls of the mill. Grinding parameters are selected such that the resultant particles have an average particle size d₅₀ of 1 to 100 μm, preferably of 3 to 30 μm, particularly preferably of 5 to 15 μm.

The above-described method for producing silicon dioxide may be carried out in the device 7.1, i.e. in this case the device 7.1 comprises all the necessary plant parts for carrying out the above-described method, but it is also possible for the device 7.1 itself to be just a part of a plant, such as for example a precipitation vessel for precipitation or gelation and/or a dryer, in which the above-described SiO₂ production process is carried out. It should be emphasized at this point that the present invention is not limited to the above-described method, but rather the SiO₂ may also be produced by other methods, in particular if the SiO₂ comprises pyrogenic silicas or silica gels.

The present invention also provides an overall plant, such as 3e, 3f, 4e and 4f, in which a reactor 4.1 for the thermal conversion of carbon-containing compounds is connected to a combined heat and power cycle 5.1, via which a proportion of the waste heat 5.3 may be extracted from the thermal conversion in 4.1 and another proportion of the waste heat may be converted into electrical energy 5.2, wherein the extracted waste heat 5.3 is used in a device 7.1, in particular in methods for producing silicon dioxide. In this case, the device 7.1 may constitute part of a plant for producing silicon dioxide. The waste heat 5.3 or the waste heat stream 5.3 may preferably be used in the device 7.1 for temperature control of a precipitation vessel and/or for drying silicon oxide, in particular silicon dioxide, such as precipitated silica, silica gel or silica purified by ion exchangers. In this way, the extracted waste heat is supplied to the device 7.1 in particular directly (see FIG. 3e or 4e) or by means of heat exchangers 8, as in FIGS. 3f and 4f. The electrical energy 5.2 is used to supply energy to a reactor 6.1 for reducing metallic compounds or in methods for producing silicon dioxide, in particular for the device 7.1. In FIGS. 3e and 3f, the energy stream 5.2 is directed to 7.1. However, the plants 3e and 3f may also be modified in such a way (not shown) that the energy stream 5.2 is conveyed to 6.1 or partly to 7.1 and partly to 6.1. Similarly, FIGS. 4e and 4f only show the energy stream 5.2 to the reactor 6.1. The plants 4e and 4f may also be modified in such a way (not shown) that the energy stream 5.2 is directed to the reactor 7.1 or partly to the reactor 6.1 and partly to the reactor 7.1.

In addition, the waste heat 6.2 from the reactor 6.1 is used in the plants 3e, 3f, 4e, 4f or the above-described modifications for reducing metallic compounds in a method for producing silicon dioxide, for example for temperature control or for drying silicon oxide in the device 7.1. Thus, waste heat streams from the reactors 4.1 and 6.1 are used jointly in the plants 3e, 3f, 4e, 4f or the above-described modifications to operate 7.1.

For further optimization of the energy balance, it is preferable (see FIGS. 3f and 4f) for the waste heat 6.2 from the reactor to be used for reducing metallic compounds in the device 7.1; in particular, the waste heat 6.2 is transferred via heat exchangers 8 (not shown in FIGS. 3e, 3f, 4e, 4f) or the above-described modifications thereof from the reactor 6.1 into the device 7.1. This may take place by connecting the waste heat, in particular a waste heat stream 6.2, of the reactor 6.1 to the device 7.1.

In addition or as an alternative to the hitherto described process variants, it is possible to convey a proportion of the hot process gases out of the reactor 6.1, preferably the proportion which cannot be further utilized in 4.1, i.e. the proportion without CO and SiO, via a hot gas line 6.3 into the combined heat and power cycle 5.1 or into the thermal power station 5.1. Preferably, a hot gas line 6.3 connects the reactor 6.1 for reducing metallic compounds to the combined heat and power cycle 5.1 or to a thermal power station 5.1, in particular for transferring the hot process gases from the reactor 6.1 into 5.1 for steam generation.

According to one alternative, the present invention provides a plant according to the invention with a reactor 4.1 for the thermal conversion of carbon-containing compounds, wherein the reactor is connected to a combined heat and power cycle 5.1, via which a proportion of the waste heat 5.3 from the thermal conversion is extracted and/or another proportion of the waste heat is converted into mechanical or electrical energy 5.2, or wherein the reactor 4.1 is connected to a thermal power station 5.1, via which the waste heat is converted into mechanical or electrical energy 5.2. The electrical energy obtained may be fed into the public electric power grid, used internally to supply power or, according to the invention, for operation of the reduction reactor 6.1 in silicon production or for producing silicon oxide, preferably precipitated silica or pyrogenic silica or silica gels, particularly preferably being used in the case of precipitated silicas and silica gels for drying or heating the precipitation vessel. The extracted waste heat may be fed into a district heating network, the waste heat preferably being used via heat exchangers in the method for producing silicon dioxide, such as for temperature control or for drying silicon oxide, in particular silicon dioxide for reutilization in the production of silicon.

A further alternative embodiment provides a combination in which the plant according to the invention, for example plants 3a, 3b, 3g, 4a or 4b, comprises, as a partial plant, a reactor 4.1 for the thermal conversion of carbon-containing compounds, wherein the reactor may be connected to a combined heat and power cycle 5.1, via which a proportion of the waste heat 5.3 may be extracted from the thermal conversion and/or another proportion of the waste heat may be converted into mechanical or electrical energy 5.2, or wherein the reactor 4.1 is connected to a thermal power station 5.1, via which the waste heat is converted into mechanical or electrical energy 5.2 and the electrical energy 5.2 is used for supplying energy to a reactor 6.1 for reducing metallic compounds, in particular an arc furnace 6.1, electric melting furnace, thermal reactor, induction furnace, melting reactor or blast furnace, preferably for producing silicon, or also for supplying energy to a device 7.1 in the production of silicon dioxide, such as for example for adjusting the temperature of a precipitation vessel, for drying silicon oxide, such as SiO₂, or also for the operation of a furnace for producing pyrogenic silica.

A person skilled in the art knows that 5.1 may also be operated in such a way that solely the waste heat 5.3 or electrical energy 5.2 or any mixed forms are used. The extracted waste heat 5.3 is here directed to 7.1; in particular, the waste heat 5.3 is transferred via a heat exchanger 8 or used directly as superheated steam, the device 7.1 preferably being part of a plant for producing silicon oxide.

If the plant according to the invention is provided with a feed line 6.3 for feeding the hot process gases from the reactor 6.1 for reducing metallic compounds via a hot gas line 6.3 into the reactor 4.1 for the thermal conversion of carbon and utilization of the waste heat 6.2 from the reactor 6.1 for reducing metallic compounds in methods for producing silicon dioxide (see for example FIGS. 3e, 3f, 4e and 4f), such as for example for temperature control of precipitation vessels or in drying silicon dioxide in the device 7.1, the waste heat 6.2 in particular is transferred particularly preferably via heat exchangers (not shown in FIGS. 3e, 3f, 4e, 4f) from the reactor 6.1 into the device 7.1.

The device 7.1 may in all plants be a precipitation vessel for precipitation or gelation of SiO₂ and/or a dryer, a tunnel oven, rotary tube furnace, rotary grate furnace, fluidized bed, rotary table furnace, circulating fluidized bed device, continuous furnace and/or a furnace for pyrolysis. Thus, superheated steam 5.3, which is obtained indirectly or directly in 4.1, for example by quenching with water, preferably deionized or distilled water, from the waste heat of 4.1 or by means of combustion of the tail gases from 4.1, may preferably be used directly for drying silicon dioxide.

With low-temperature steam 5.3, the operation of contact dryers 7.1, for example plate dryers or particularly preferably rotary tube dryers, suggests itself. The power 5.2 obtained by way of 5.1 may be used directly to operate primary dryers. These are preferably tower spray dryers or spin flash dryers. It is clear to a person skilled in the art that the above-stated list should be understood to be solely by way of example and that other conventional dryers may also be used.

With regard to reactors 4.1 or 6.1, it is the case that all the waste heat or indeed proportions of the waste heat arising therein, for example from the reaction zone, the hot reactor parts, steam generated by quenching with water, preferably deionized or distilled water, in 4.1 or indeed the waste heat of the reaction products, such as gases or other material streams, should be deemed to be utilized waste heat according to the invention. According to the invention, in particular the residual gas (tail gas) is combusted and the waste heat formed used in the plant according to the invention.

Preferably, the plant operates continuously for 24 hours 7 days a week, such that the waste heat is also used, directly or via the heat exchangers 8, in a continuous cycle, in particular via primary and/or secondary circuits. The consequently achievable energy saving may amount to between 1 to 10 kWh, preferably 2 to 6 kWh, particularly preferably around 2 kWh, per kilogram of dried silicon dioxide from 7.1. It is clear to a person skilled in the art that the particular energy balance achieved depends directly on the residual moisture content and the dryer device used and on further process parameters, such that the stated values should only be understood as guide values. When using the obtained electrical energy of around 1 to 10 kWh, preferably around 5 kWh, per kilogram of carbon black for reducing in each case one kilogram of silicon dioxide to yield molten silicon in 6.1, there is a potential saving of 1 to 10 kWh, in particular of 4 to kWh, taking account of the method for producing silicon dioxide. To produce around a kilogram of molten silicon, the energy saving may increase to 5 kWh to 20 kWh, in particular it may lie in the region of 17 kWh taking account of the overall process, including the production of silicon dioxide and carbon black and the reaction thereof to yield silicon.

According to a further preferred embodiment, as illustrated in FIGS. 3e, 3f, 4e and 4f, the waste heat 6.2 may be used together with the waste heat 5.3 in a method for producing silicon dioxide for the device 7.1, preferably for temperature adjustment or for drying silicon dioxide, in particular precipitated silica or silica gel or precipitated silica or silica gel which has been purified by means of ion exchangers. Preferably, the waste heat 6.2 and/or 5.3 is used to dry the silica by way of one or more heat exchangers 8 (not shown in FIGS. 3e, 3f, 4e, 4f). In all the plants, the device 7.1 may be part of a plant for producing silicon dioxide.

Heat exchangers 8 are preferably used to prevent contamination of the silicon dioxide, in particular high purity silicon dioxide. In these heat exchangers the waste heat from the reactor 6.1 is used by means of a secondary circuit in a method for producing silicon dioxide, such as for drying silicon dioxide or adjusting the temperature of a precipitation vessel. Conventionally, in the heat exchangers and/or in the feed and discharge lines for the waste heat, the medium used takes the form of water, a conventional cooling fluid or other media sufficiently well known to a person skilled in the art.

A convenient plant 3h, 3i, 4g or 4h also provides for utilization of the waste heat 6.2 from the reactor 6.1 for reducing metallic compounds solely in the method for producing silicon dioxide in the device 7.1, in particular for adjusting the temperature of a precipitation vessel 7.1 or dryer 7.1 for drying silicon oxide; in particular the plant 3i or 4h may be such that the waste heat 6.2 from the reactor 6.1 is conveyed via heat exchangers 8 into the device 7.1 by means of heat exchangers 8.

It goes without saying that the device 7.1, which may in particular be a reactor, precipitation vessel and/or dryer, is merely a part of a partial or overall plant for producing silicon oxide and is connected or connectable upstream and/or downstream to further installations or devices, in order for example to produce high purity silicon dioxide from contaminated silicates.

In particular, the feed line 7.2 should be regarded, in all the plants as a direct or indirect feed line into the reactor or as a material stream into the reactor 6.1. For instance, the silicon dioxide dried in 7.1 may preferably be subjected to further processing steps in 8.1, before it is supplied to the reactor 6.1. These steps are in particular grinding, formulation, briqueting. The flow of electrical energy according to 5.2 may also be used in these steps.

According to the invention, the waste heat from the reactor 4.1 is used for the thermal conversion of carbon-containing compounds for producing electrical energy, in particular by means of a combined heat and power cycle or a thermal power station. Waste heat also encompasses the waste heat from the tail gases and the waste heat which arises through combustion of the tail gas. In this respect, it is particularly preferable for the waste heat to be used wholly or partially, in particular directly or indirectly, in methods for producing silicon dioxide, such as for temperature adjustment or for drying. Preferably, superheated steam from 4.1 and/or 5.1 may be used in 7.1 for drying or temperature adjustment.

This combined use according to the invention of the waste heat was hitherto inconceivable for a person skilled in the art, because the possible mutual contamination could have led to significant process control problems. It is the joint use of silicon dioxides purified in or from aqueous systems and carbon black or pyrolyzed carbohydrates for producing high purity silicon which for the first time makes this combined synergistic utilization of the waste heat or thermal energy possible.

The electrical energy obtained may preferably be used to operate a reactor 6.1 for reducing metallic compounds or to operate devices 7.1 in methods for producing silicon dioxide, preferably to operate dryers, such as primary dryers, furnaces for producing pyrogenic silica for producing silicon or for adjusting the temperature of precipitation vessels or for the operation of other method steps which work with electrical power. As explained above, the energy balance of the overall process comprising carbon black production, the production of silicon oxide and/or reduction of the silicon dioxide is improved considerably over known plants and the known use from the prior art.

For instance, the energy balance of the silicon dioxide process may be improved considerably preferably in the particularly energy-intensive steps, such as for example heating of the precipitation vessel or in drying steps for the silicon dioxide and further method steps to which energy has to be supplied. By combined process control and the consistent use of waste heat, of combustible residual gases and/or of the recirculation of the hot gas from 6.1, all the material circuits in the plant may be operated with an energy balance which is improved relative to known methods from the prior art. For instance, recirculation of the hot gases, carbon monoxide and silicon oxide, in particular gaseous SiO, fully into the reactor 4.1 leads to process intensification; in particular the formation of carbon monoxide during the method for producing carbon black may be reduced in the overall balance. The overall process in the overall plant according to the invention or indeed in the partial plants leads to a considerable reduction in the amount of carbon dioxide and/or carbon monoxide formed over the overall process during the production of silicon, in particular from silicon dioxide and carbon-containing compounds, such as carbon black or pyrolyzed high purity carbohydrate.

It is clear to a person skilled in the art that the stated plants may comprise a plurality of reactors in each process stage, instead of in each case one reactor, and that this may in particular allow the overall process to be carried out continuously and without interruption. The reactors may be operated continuously or also discontinuously.

To produce solar silicon in particular, the plant according to the invention may, for further purification of the elemental silicon obtained from 6.1, contain additional purification units such as for example plants or plant components for zone melting or for purification by means of Scheil solidification. Alternative purification methods for purifying elemental silicon from reduction furnaces are known to a person skilled in the art and may be applied.

The following figures explain the plants according to the invention in greater detail, without limiting the invention to this example.

Extending the plant according to the invention by an plant for Scheil solidification may for example be considered if the educts introduced by material streams 4.4 and 7.2 are contaminated with specific sulfur-containing compounds, a factor which in particular needs to be taken into account for the carbon stream.

Depending on the sulfur contaminants present in the raw material streams, the following cases may arise:

If the contaminant is elemental sulfur, this vaporizes at above 444.6° C. and is expelled from the reactor 6.1 with the furnace gas CO/SiO. On combustion of the furnace gas, SO₂ arises in the reactor 4.1. Due to an excess of hydrogen in the reactor 4.1, H₂S, which must be disposed of, is formed therefrom.

If the sulfur is organically bound, it decomposes below 800° C. to yield CS₂ or H₂S or other gaseous compounds. The organically bound sulfur also leaves the reactor 6.1 after furnace gas combustion as SO₂. Due to the excess of hydrogen in the reactor 4.1, H₂S, which must be disposed of, is formed therefrom.

Further possible contaminants are sulfates, for example from SiO₂ production.

In the presence of carbon, calcium sulfate reacts according to

CaSO₄+C=CaO+SO₂+CO

At above 801° C., the equilibrium is shifted to the right. Sulfate sulfur is driven from the reactor 6.1 with the furnace gas and eliminated from the circulation process as H₂S as described above. The CaO remains in the reactor 6.1 and forms with the silicon dioxide a lime silicate, which is then reduced and contaminates the silicon. This contamination can be removed from the elemental silicon by means of Scheil solidification.

Potassium sulfate reacts with carbon according to

K₂SO₄+2C=2K+SO₂+2CO

At above 1406° C., the equilibrium is shifted to the right. All the components are gaseous and leave the reactor 6.1.

Sodium sulfate reacts in the reactor 6.1 according to

Na₂SO₄+2C=2Na+SO₂+2CO

Equilibrium of the reaction at 1190° C.; all the components are gaseous and leave the reactor 6.1.

However, K and Na also react with the SiO according to

2K+SiO=Si+K₂O below 950° C.

2Na+SiO=Si+Na₂O below 1150° C.

These reverse reactions occur in part in the reactor 6.1, such that the SiO₂ forms silicates with the alkalis. The silicates are reduced in the reduction zone, while the Na and K then in part vaporize again. In this manner, Na and K accumulate in the reactor 6.1 and in the eliminated microsilica.

Further possible contaminants are sulfides such as FeS₂, MnS, MgS and CaS. A roasting reaction cannot occur in the Si arc furnace since no free oxygen is present.

Pyrites accordingly decompose at below 700° C. to form FeS and S. FeS reacts with Si according to

FeS+Si=SiS+Fe equilibrium at 1250° C.

SiS evaporates from the reactor 6.1, while Fe is dissolved in the Si. Additional purification may proceed by Scheil solidification.

Manganese sulfide MnS reacts according to:

MnS+Si=SiS+Mn equilibrium at 2000° C.

SiS evaporates, while Mn dissolves in the Si.

Additional purification can only proceed by Scheil solidification.

Magnesium sulfide MgS reacts according to:

2MgS+3Si=2SiS+Mg₂Si equilibrium at 1940° C.

SiS evaporates. Mg dissolves in the Si. Additional purification can only proceed by Scheil solidification.

In the case of calcium sulfide CaS, a reaction with Si is not possible until above 2600° C. CaS is therefore tapped off with Si and separated by Scheil solidification.

Reference numerals:
1, 1a, 2, 2a, 3, 3a, 3b, 3c, 3d, 3e, 3f, 3g, 3h, 3i, 4, 4a, 4b, 4c, 4d, 4e, 4f, 4g, 4h: alternative plants or combinations of plants, overall plant;

### Reactors/Devices:

4.1: reactor for the thermal conversion of carbon-containing compounds, for example reactors for producing carbon black or for pyrolysis of carbohydrate, such as the pyrolysis of sugar optionally in the presence of silicon dioxide;
5.1: combined heat and power cycle, thermal station
6.1: reactor for producing silicon from silicon dioxide and carbon, for example electric melting furnaces, induction furnaces, arc furnaces (further alternatives are mentioned in the description);
7.1: device for use for producing silicon dioxide, for example in a drying stage, preferably a dryer, for example fluidized bed reactor or other reactor for drying substrates, a reactor (furnace for producing pyrogenic silica) or also a precipitation vessel;
8.1: device/machine/installation for further processing material streams 4.2 and 4.3 comprising for example a mixing unit in which carbon and silicon dioxide are mixed as homogeneously as possible and/or a unit for producing shaped articles from SiO₂ and C by granulation, tableting, pelletising, briqueting or other suitable measures well known to a person skilled in the art and/or a suitable grinding apparatus
8: heat exchangers, preferably comprising a secondary circuit and enabling the discharge of waste heat (thermal energy) from processes, in 4.1 and/or 6.1, and supply of thermal energy into endothermic processes, in particular in 7.1 for drying;

### Material Streams

4.2: material stream of the carbon produced in the reactor 4.1, preferably in the form of carbon black or charcoal or the pyrolysis product of a carbohydrate
4.3: material stream of silicon dioxide arising as a by-product in the reactor 4.1
4.4: supply of a source of carbon, for example gas, preferably natural gas, oil or sugar into the reactor 4.1
6.3: hot gas line for conveying SiO and CO from the reactor 6.1 into the reactor 4.1.
7.2: material stream, for example feed line(s) and optionally production stages, via which the product from 7.1 can be transferred to the reactor 6.1 or to further processing 8.1,
8.2: material stream of the product from further processing 8.1 to the reduction reactor 6.1

### Energy Streams

5.2: electrical energy flow, for example line for conducting electrical energy;
5.3 thermal energy flow or energy flow, such as superheated steam or low-temperature steam, which is used, for example by tubes, optionally with connected heat exchangers 8, for utilizing the waste heat from 4.1, which is extracted via 5.1, for drying or temperature adjustment in 7.1;
6.2: thermal energy flow, for example line(s), in particular with connected heat exchangers 8, for utilizing the waste heat from 6.1 in 7.1, preferably as a secondary circuit;

In the Figures:

FIGS. 1, 1a:

show alternative plants combinations or partial combinations of reactors for producing carbon and silicon; connected by the silicon oxide circuit 4.2/6.3.

FIGS. 2, 2a:

show alternative plants combinations or partial combinations of reactors for producing carbon and silicon; connected by the silicon oxide circuit 4.2/8.2/6.3

FIGS. 3a to 3i show combinations according to the invention of plants in which the waste heat or waste gas streams of the reactors 4.1 and 6.1 are used, for example in the temperature-adjusting step or in the drying step in the production of silicon dioxide, partly via a combined heat and power cycle (5.1, 5.3 or 5.2) or via heat exchangers 8. In addition, in alternatives 3a and 3b the energy streams obtained by means of the combined heat and power cycle from the waste heat and the waste gases of the reactor 4.1 are used to operate the reduction reactor 6.1.

FIGS. 4a to 4h show combinations according to the invention of plants in which the waste heat or waste gas streams of the reactors 4.1 and 6.1 are used, for example in the temperature-adjusting step or in the drying step in the production of silicon dioxide 7.1, partly via a combined heat and power cycle (5.1, 5.3 or 5.2) or via heat exchangers 8. In addition, in alternatives 4a and 4b the energy streams obtained by means of the combined heat and power cycle from the waste heat and the waste gases of the reactor 4.1 are used to operate the reduction reactor 6.1. Unlike in FIGS. 3 to 3i, the plants according to FIGS. 4a to h additionally comprise a further processing apparatus 8.1, which ensures that the raw materials SiO₂ and C are supplied to the reduction reactor 6.1 in optimized form and at an optimum weight ratio.

FIGS. 3 and 4 show a plant 3 comprising a reactor 4.1 for the thermal conversion of carbon-containing compounds, the reactor being connected to a combined heat and power cycle 5.1, via which a proportion of the waste heat 5.3 is extracted from the thermal conversion and another proportion is converted into mechanical or electrical energy 5.2. The extracted heat is discharged via the line 5.3. Depending on the process control, all the waste heat or a proportion of the waste heat may be used to adjust the temperature of the device 7.1 (see FIGS. 3a to i and 4a to h) or for energy recovery. The waste heat may be used to adjust the temperature of a precipitation vessel or indeed to operate dryer 7.1. The electrical energy produced may be forwarded via 5.2. The electrical energy may be fed into the public electric power grid or used in the method for producing silicon dioxide or directly in an overall process for producing silicon in an electric furnace, for example an arc furnace 6.1 (see FIGS. 3a, 3b, 3g, 4a to 4g).

According to plant 3c-f and 4c-d, 5.1 may be used for power generation, it also being possible to use the power to operate 7.1 or other plant parts.

A specific plant according to the invention, as illustrated schematically in FIG. 4e, with its energy and material streams, will be explained in more detail below.

This plant comprises a plant for producing silicon dioxide 7.1, with a precipitation vessel, apparatuses for working up the precipitation suspension such as for example filter presses and a drying apparatus for the high purity silicon dioxide obtained. As the input into 7.1, 9.3 kg of water glass are introduced per kg of finished SiO₂ discharged from 7.1. This water glass contains 2.15 kg of SiO₂ per kg of finished SiO₂ and 7.2 kg of water per kg of finished SiO₂, which has to be evaporated during drying. For this purpose, 14.33 kWh of energy are required per kg of SiO₂ obtained from 7.1. This energy is obtained in part from the waste heat or from combustion of the tail gas of the carbon black reactor 4.1 contained in the plant via the energy stream 5.3 and has to be obtained upon first startup of the plant in part from an external energy source.

Further energy input into 7.1 is required in order to be able to perform precipitation at temperatures of between 60 and 96° C. However, this quantity of energy is quite small in comparison with the energy expended during drying. Once the reduction reactor 6.1 has been started up, the waste heat of the reduction reactor 6.1 may additionally be used, by way of the heat stream 6.2, to dry the silicon dioxide. At this stage, the total energy requirement of 14.33 kWh energy per kg of SiO₂ obtained from 7.1 may be covered by energy streams 5.2 and 6.2.

2.15 kg of SiO₂ and 6.45 kg of steam per kg of SiO₂ are obtained as output from 7.1. The SiO₂ is supplied to a pelletizing installation 8.1 via the material stream 7.2. Furthermore, 1 kg of carbon black is supplied to the pelletizing installation via 4.2 and 0.65 kg of SiO₂ is supplied thereto from the carbon black reactor 4.1 via 4.3. The three components are mixed together and press-molded into pellets, such that a total of 3.789 kg of SiO₂/C pellets are obtained as output from 8.1. By means of these pellets, a stream 8.2 of 3.789 kg of SiO₂/C per kg of finished silicon, isolated from 6.1, is supplied to an arc furnace 6.1. To produce one kg of finished silicon, an energy input of 13 to 17 kWh is required in the arc furnace 6.1.

1 kg of the final product, i.e. elemental silicon, a material stream of 2.332 kg of CO per kg of finished silicon and a material stream of 0.481 kg of SiO per kg of finished silicon are obtained as output from the arc furnace. Furthermore, 9 kWh of energy per kg of finished silicon are dissipated by cooling and latent heat, which is supplied as energy stream 6.2 to the silicon dioxide drying stage 7.1.

The material streams of CO and SiO are combined, such that an overall material stream 6.3 of 2.813 kg of SiO/CO per kg of finished silicon is supplied to the carbon black reactor 4.1. In addition to this material stream, 1.28 kg of oil per kg of carbon produced and 3.843 kg of water per kg of carbon produced are supplied to the carbon black reactor 4.1 via 4.4 for quenching purposes. In this way, an output is achieved of 1.281 kg carbon in the form of carbon black, which is supplied to the pelletizing stage 8.1 via the material stream 4.2. Furthermore, 0.656 kg of pulverulent SiO₂ is obtained, which is supplied to the pelletizing stage 8.1 via the material stream 4.3. Finally, a tail gas with a calorific value of 5 kWh/kg C and 3.847 kg of steam is obtained, which are supplied via the combined heat and power cycle 5.1 and the energy stream 5.3 to the precipitation stage 7.1. The energy stream 5.2 shown in FIG. 4e is not used in this example, but instead the energy obtained from the combined heat and power cycle is used via 5.3 for drying of the SiO₂.

Prior to initial startup of the arc furnace 6.1, the silicon dioxide production 7.1 and the carbon production in 4.1 must firstly be performed once. After startup of the arc furnace 6.1, the above-described SiO/SiO₂ cycle is established between the arc furnace 6.1 and the carbon black reactor 4.1. Finished silicon is drawn off from this cycle and new SiO₂ from the precipitation stage 7.1 is introduced into the cycle via 7.2. The SiO and CO formed in the arc furnace during the reduction reaction are utilized in the carbon black reactor. The main waste product of the cycle is thus principally CO₂, which has to be disposed of. Further waste products may arise in small to very small quantities due to educt contaminants, such as for example H₂S if sulfur contaminants are present therein.

The method described above by way of example leads to a marked reduction in the quantities of starting substances, i.e. of approx. 20% for water glass and of approx. 10 kWh energy equivalent for natural gas.

1. A plant comprising at least one reactor (4.1) for the thermal conversion of carbon-containing compounds and at least one reactor for reducing metallic compounds (6.1), wherein the reactor (6.1) is supplied with carbon produced in the reactor (4.1), preferably in the form of at least one of carbon black, charcoal, and a pyrolysis product of at least one carbohydrate via a material stream (4.2), wherein silicon dioxide arises as a by-product in the reactor (4.1) via a material stream (4.3), and wherein a mixture of carbon monoxide and silicon monoxide arises as a by-product in the reactor (6.1) that is returned to the reactor (4.1) via a material stream (6.3).

2. The plant according to claim 1, further comprising a device (8.1) for further processing of the material stream (4.3) and of the material stream (4.2), such that the material streams (4.2) and (4.3) are fed to the device (8.1) and a product of the further processing is forwarded to the reactor (4.1) via a material stream (8.2).

3. The plant according to claim 2, wherein the device (8.1) comprises at least one of a mixing unit in which carbon and the silicon dioxide are mixed as homogeneously as possible, a unit for producing shaped articles of carbon and silicon dioxide, and a grinding apparatus.

4. The plant according to claim 1, wherein the material stream (6.3) is conveyed via a hot gas line.

5. The plant according to claim 1, wherein the reactor (6.1) comprises one of an arc furnace, an electric melting furnace, a thermal reactor, an induction furnace, a melting reactor, and a blast furnace.

6. The plant according to claim 1, wherein the reactor (4.1) for the thermal conversion of carbon-containing compounds is connected to a combined heat and power cycle (5.1), via which at least a proportion of waste heat (5.3) is extracted, or at least another proportion of waste heat is converted into mechanical or electrical energy (5.2), or a combination thereof.

7. The plant according to claim 6, wherein the extracted waste heat (5.3) is transferred into a device (7.1) by a heat exchanger (8).

8. The plant according to claim 6, wherein the electrical energy (5.2) is supplied to the reactor (6.1).

9. The plant according to claim 4, wherein the hot gas line (6.3) is configured to supply at least a proportion of the hot gases from the reactor (6.1) to a combined heat and power cycle or to a thermal power station (5.1).

10. The plant according to claim 7, wherein the plant is configured to direct a waste heat stream (6.2) of the reactor (6.1) to the device (7.1) for reducing metallic compounds, and wherein at least a proportion of the energy of the waste heat stream (6.2) is utilized in the device (7.1).

11. The plant according to claim 10, wherein the waste heat stream (6.2) of the reactor (6.1) is connected to the device (7.1).

12. The plant according to claim 1, wherein the reactor (6.1) and the reactor (4.1) are of an airtight construction to prevent penetration of oxygen.

13. A method of operating the plant according to claim 2, comprising producing silicon in the reduction furnace (6.1) from silicon dioxide and carbon.

14. The method according to claim 13, comprising operating the plant by control of the material streams (4.2), (4.3) and (6.3) or (4.2), (4.3), (6.3) and (8.2) such that at least 95% of the silicon introduced by a material stream (7.2) in the form of silicon dioxide is discharged from the reactor (6.1) as pure silicon.

15. The method according to claim 13, the comprising supplying silicon dioxide to the reduction furnace (6.1) directly or via the device (8.1).

16. The method according to claim 14, comprising introducing a precipitated silica or silica gel or a pyrogenic silica or mixed forms thereof or mixtures thereof into the plant by the material stream (7.2).

17. A method of producing silicon, comprising:
producing silicon dioxide in a reactor (4.1); and
using the silicon dioxide for the thermal conversion of carbon-containing compounds for producing silicon by means of a reduction furnace (6.1).

18. The plant according to claim 1, wherein the reactor (4.1) is connected to a thermal power station (5.1), via which the waste heat is converted into mechanical or electrical energy (5.2).

19. The plant according to claim 7, wherein the device (7.1) is configured as at least one of a precipitation vessel, a reactor, and a dryer as part of a plant for producing silicon dioxide.

20. The method according to claim 13, wherein the silicon dioxide and the carbon do not exceed the following limit values for contaminants: aluminum, boron, calcium, iron, nickel, phosphorus, titanium, zinc in each case at most 10 ppm.
